(19) United States
(12) Patent Application Publication
(10) Pub. No.: US 2012/0184159 A1
(43) Pub. Date: Jul. 19, 2012

(54) Amphibious Vehicle That Tilts While Floating To Facilitate Climbing Onto Sea Ice

(75) Inventor: Graham Fuglsang, Yellowknife (CA)

(73) Assignee: Norseman Canadian Industries LTD., Yellowknife, Northwest Territories, CA (US)

(21) Appl. No.: 13/497,158

(22) PCT Filed: Sep. 21, 2010
(86) PCT No.: PCT/CA2010/001502

§ 371 Date: Mar. 20, 2012

(30) Foreign Application Priority Data
Sep. 22, 2009 (CA) 2679824

(51) Int. Cl. B60F 3/00; B63B 43/14; B63C 3/00; B63B 43/06

(52) U.S. Cl. 440/12.63

(57) ABSTRACT

A tracked amphibious vehicle having adjustable ballasting means for changing between a neutral-trim position and an ice-engaging-end-up trim position when floating so as to facilitate moving from floating in water to the surface of adjacent floating ice.

### FIELD OF THE INVENTION

The present invention relates to amphibious vehicles, particularly amphibious vehicles for use on floating ice on ice-covered water bodies, such as sea ice.

### BACKGROUND OF THE INVENTION

Travel over floating ice is frequently desirable, for example, in polar, particularly arctic, scientific and exploratory expeditions, and in association with resource extraction, notably oil and gas exploration and extraction.

Floating ice is often interrupted by areas of open water. Further, a problem associated with travel over floating ice, one that varies in significance from a minor impediment to a life-threatening danger, is the risk of breaking through the ice. The thickness and solidity of floating ice varies in an unpredictable manner and such differences in ice condition are typically not apparent from the upper surface of the ice, especially when the ice is covered with snow, as it often is. Therefore, it is desirable for a vehicle for use on floating ice to be able to: survive breaking through the ice; manoeuver in water; and climb from water on to floating ice.

An example of a known vehicle for use with floating ice is disclosed in U.S. Pat. No. 2,551,967 (Ice Breaker; Pouliot; 8 May 1951), which discloses a track-driven amphibious vehicle having elaborate cutters and other paraphernalia for cutting and handling ice. Lines 17 to 25 of column 2 of U.S. Pat. No. 2,551,967, read: “Generally speaking, it is preferred that the hull A and propelling tracks C of the vehicle be shaped and disposed after the fashion of the earlier type of tanks; that is, the path of the tracks and the shape of the hull will resemble somewhat a forwardly-canted parallelogram (see FIG. 1). Thus the front end of the vehicle will have a shovel nose shape which is particularly adapted for climbing up on obstacles.” The Pouliot amphibious vehicle uses a conventional propeller (“screw”) and rudder for propulsion and directional control while floating in water. In addition to the forwardly-canted parallelogram configuration of the tracks, for aid in climbing an obstacle, the Pouliot patent discloses driven toothed wheels (serrated disks) projecting downward from the hull for engaging such obstacles. Presumably for additional buoyancy, the housings around which the tracks are disposed are structurally water-tight with the main hull.

Tracked amphibious vehicles, and equipment, having the tracks disposed around buoyant chambers are well known with respect to amphibious vehicles for use in swampy or marshy conditions. For example, U.S. Pat. No. 3,842,785 (Amphibious Marsh Craft; Rivet; 22 Oct. 1974), U.S. Pat. No. 6,655,757 (Head and tail sprocket assemblies for a marsh excavator; Prestenbach; 2 Dec. 2003), and U.S. Pat. No. 6,918,801 (Amphibious vehicle; Wilson, Jr., et al.; 19 Jul. 2005), disclose tracked vehicles for use in swamps and marshes wherein each track surrounds a pontoon, with each track kept in position by means of ridges or grooves on the surface of the pontoon. As there is considerable friction in the track arrangement, the vehicles are presumably slow-moving.

Further, U.S. Pat. No. 3,951,093 (Amphibious air track vehicle; Poche; 20 Apr. 1976) discloses a marsh vehicle generally similar to those disclosed in the above three patents in that the tracks surround the pontoons. The vehicle disclosed in this patent has the additional feature of open-bottom chambers between the pontoons into which air may be injected to increase buoyancy or from which air may be evacuated to reduce buoyancy.

As set out in the Abstract, U.S. Pat. No. 4,433,634 (Tracked, amphibious vehicle with track securement and guide means; Coast; 28 Feb. 1984), discloses a track-driven amphibious vehicle that includes, “two spaced, parallel pontoons joined by a centrally located operator's platform structure, with each pontoon having a moveable track for propulsion, with each track supported on its pontoon by for and after sprocket wheel sets and a series of larger bogie wheels at its bottom and smaller guide wheels at its top.”

U.S. Pat. No. 6,820,566 (Means of providing additional modular armor protected buoyancy to tracked and wheeled vehicles; Brown; 23 Nov. 2004), discloses armor-protected buoyancy modules for use on tracked or wheeled vehicles, to provide the vehicles with amphibious capability. The buoyancy modules are shown mounted on the sides of the vehicle above the tracks or wheels. The Brown patent contemplates inflating each individual module to a different extent so as to adjust the overall buoyancy of the vehicle for varying load weight and center of gravity conditions. The Brown patent also contemplates sequentially deflating the modules to increase the weight borne on the tracks or wheels as the vehicle engages the underwater bed adjacent the water's edge, so as to increase traction and enhance the vehicles ability to exit the water via a steep bank.

### SUMMARY OF THE INVENTION

In one aspect, the present invention provides for a method for moving a tracked amphibious vehicle from the water to the surface of adjacent floating ice, including the steps of: a) positioning the vehicle in an end-down trim position in which the portions of the track opposite the end that is down are raised sufficiently high to engage the edge of the ice; b) bringing the raised portions of the track into engagement with the ice; c) raising the end of the vehicle that was down in the end-down trim position so as to bring the vehicle into a more-level position with the tracks engaging the ice edge; and d) driving the vehicle onto the ice using the tracks.

In another aspect, the present invention provides for a vehicle for implementing the method, the vehicle comprising adjustable ballasting means for changing between a level-trim position and a bow-down-trim position when floating.

In another aspect, the present invention provides for a vehicle configured for use on floating ice, the vehicle including: a track assembly, including a frame and two driveable tracks attached thereto, the tracks having an ice-engaging end; a hull, mounted to and supported by the track assembly, wherein the track assembly and hull have positive buoyancy; and an arrangement for adjusting the attitude of the vehicle between a neutral-trim position and an ice-engaging-end-up trim position when the vehicle is floating; wherein, in use the vehicle may be moved from floating in water onto adjacent ice by, with the vehicle in the ice-engaging-end-up trim position, bringing the ice-engaging end of the tracks into engagement with the ice and driving the tracks so as to draw a portion of the tracks onto the ice and then adjusting to the neutral-trim position and continuing to drive the tracks.

The arrangement for adjusting the attitude of the vehicle may include an adjustable ballasting arrangement including one or more tanks and water transfer assemblies whereby liquids may be selectively: drawn from and expelled to the surroundings, or shifted between tanks, or drawn from and expelled to the surroundings and shifted between tanks. The tanks may include two pontoons, one pontoon located within one of the tracks and the other pontoon located within the other of the tracks. Each pontoon may be segregated into two or more chambers.

The arrangement for adjusting the attitude of the vehicle may include an adjustable ballasting arrangement comprising a tank located in the hull and a water transfer assembly whereby water may be selectively drawn into the tank from the surroundings and expelled from the tank to the surroundings. The neutral-trim position may be a level-trim position.

The frame may include watertight hollow structural components having integral floatation. The watertight hollow structural components may include two longitudinally extending beams and each track may be supported by an array of idler wheels and the idler wheels of one track may be mounted to one of the beams and the idler wheels of the other track may be mounted to the other of the beams. The watertight hollow structural components may include one or more crossbeams interposed between the longitudinally extending beams.

Each track may be supported by an array of idler wheels and each track may be driven by a drive gear located at the ice-engaging end. The vehicle may have a front and a back, and the ice-engaging end may be at the back.

The vehicle may include a winch assembly located at the ice-engaging end for assisting in bringing the ice-engaging end into engagement with ice when the vehicle is floating in water.

The addition and subsequent removal of weight in the form of ballast water, and/or the transfer of onboard fluids, enables the vehicle to climb an abutment (the ice cover) from a floating position by altering and then correcting it's longitudinal attitude (trim).

### SUMMARY OF THE DRAWINGS

FIG. 1 is a side elevation view of a tracked amphibious vehicle with snow plow, embodiment of the present invention.

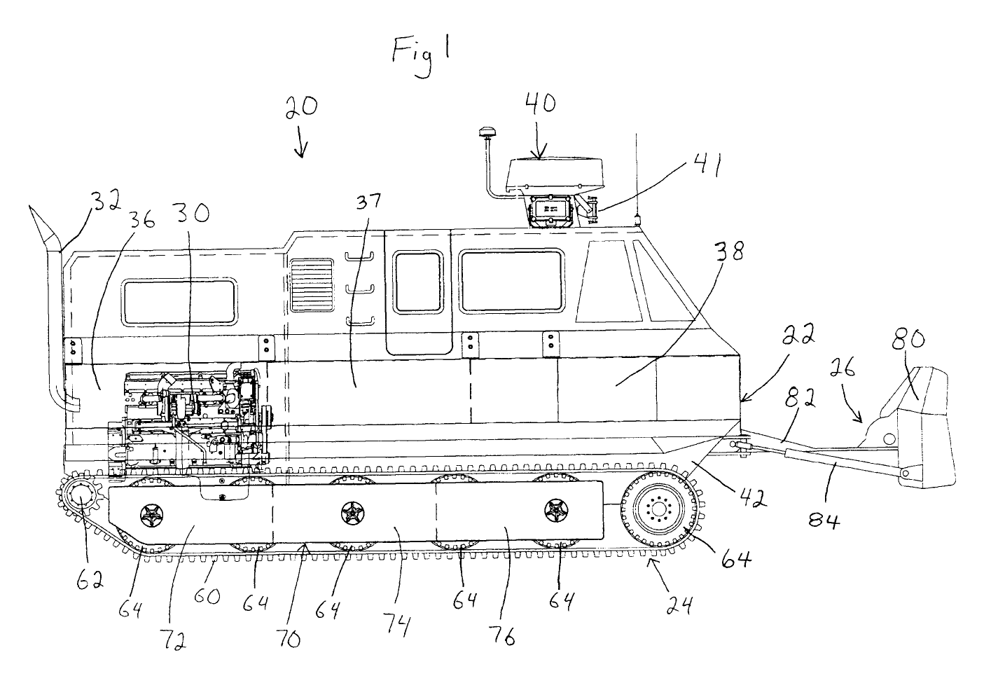

FIG. 2 is a partially transparent rear elevation view of the embodiment of FIG. 1.

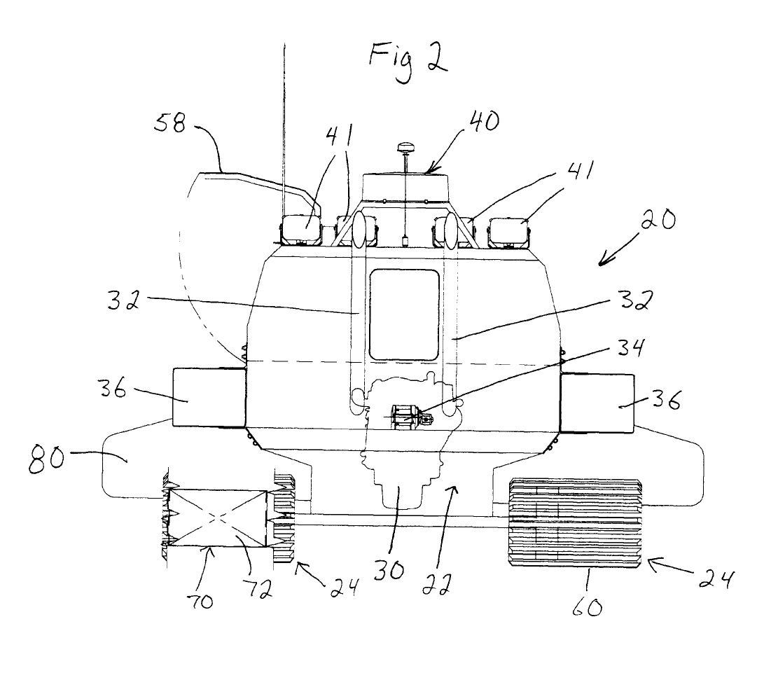

FIG. 3 is partially transparent top plan view of the embodiment of FIG. 1.

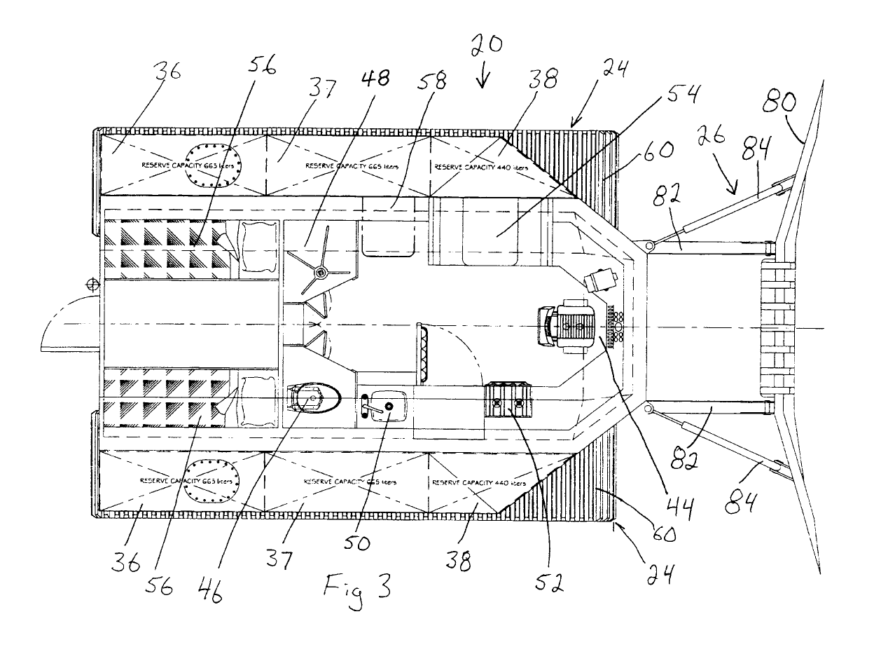

FIG. 4 is a side elevation view of the embodiment of FIG. 1, shown on floating ice.

FIG. 5 is a side elevation view of the embodiment of FIG. 1, shown floating in level trim in water adjacent floating ice.

FIG. 6 is a side elevation view of the embodiment of FIG. 1, shown ballasted so as to provide full-bow-down trim and located adjacent floating ice.

FIG. 7 is a side elevation view of the embodiment of FIG. 1, shown ballasted so as to provide full-bow-down trim, with the rear end of the tracks abutting the edge of the floating ice and with a stabilizing line deployed.

FIG. 8 is a side elevation view of the embodiment of FIG. 1, shown ballasted so as to provide partial-bow-down trim, with the rear end of the tracks engaging the edge of the floating ice and with a stabilizing line deployed.

FIG. 9 is a side elevation view of the embodiment of FIG. 1, shown ballasted so as to tend to provide level trim, with the rear end of the tracks on the floating ice and with a stabilizing line deployed.

FIG. 10 is a perspective view of a side-integral-tank track assembly of an embodiment of the present invention, with sections of the tracks not shown.

FIG. 11, is a perspective view of a full-integral-tank track assembly shown in FIG. 10, having pontoons, with sections of the tracks not shown.

In the drawings, the most closely spaced hatching is used to indicate water within a chamber or tank; the intermediately spaced hatching is used to indicate a sectional view of floating ice; and the most widely spaced hatching is used to indicate a sectional view of snow overburden.

### DETAILED DESCRIPTION WITH REFERENCE TO THE DRAWINGS

A tracked amphibious vehicle 20 embodiment of the present invention is shown in the Figures. The tracked amphibious vehicle 20 includes a hull 22, a track assembly 24 and a snow-plow assembly 26.

Within, and attached to, the hull 22, there are disposed, an engine 30, engine exhausts 32, a winch 34 and associated winch line 35, two aft buoyancy tanks 36, two middle buoyancy tanks 37, two forward buoyancy tanks 38, navigation and communication devices 40, lights 41, a bow ballast tank 42, a control station 44, various crew amenities, including a toilet 46, shower 48, sink 50, stove 52, dinette 54 and berths 56, and a door 58. At least the lower portion of the hull 22 is watertight. The hull 22 is preferably a welded plate aluminum envelope of marine-grade construction.

The track assembly 24 includes a pair of continuous tracks 60, each track 60 associated with one drive gear 62 and six idler wheels 64. The tracks 60 are conventional such tracks. Preferably, the tracks 60 are 48 inches wide.

The means for controlling the drive gears 62 is configured such that each track 60 may be controlled independently. For example, the drive gears 62 may be driven by a common means but braked independently, such that one track may be stopped or slowed while the other is moving. Alternatively, the drive gears 62 may be driven by independent means (for example hydraulic motors) such that one track 60 may be driven in one direction and the other track 60 driven in the same direction at the same or a lesser or greater speed, stopped or driven in the opposite direction.

Disposed within each track 60, there is a pontoon 70, segregated by watertight bulkheads into three separate chambers, an aft chamber 72, middle chamber 74 and forward chamber 76.

The snow-plow assembly is conventional and comprises a blade 80, supporting struts 82 and hydraulic rams 84, the latter used to raise, lower and angle the blade 80.

The tracked amphibious vehicle 20 includes, within the hull 22, a hydraulic pump (not shown) driven by the engine 30, for powering and controlling various devices, including the winch 34 and hydraulic rams 84.

Although not shown in the drawings, the tracked amphibious vehicle 20 includes conventional means for transferring water between the tanks and between chambers, and from and to the surrounding environment. The tracked amphibious vehicle 20 also includes means for preventing water in the tanks and chambers from freezing (not shown); such freezing prevention means may include insulation and heating means.

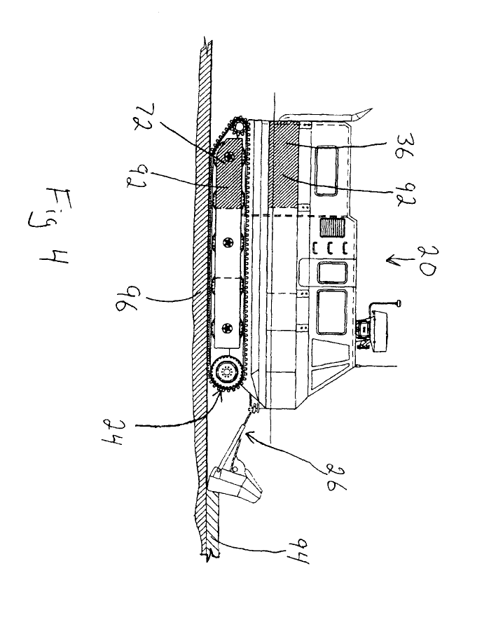

As shown in FIG. 4, the tracked amphibious vehicle 20 may be used to remove snow overburden 94 from floating ice 96, for example, so as to create or maintain an ice road.

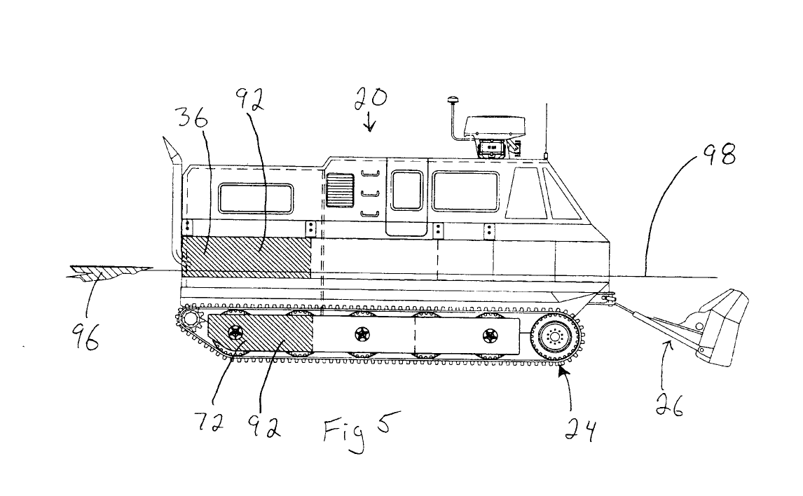

Preferably, the tracked amphibious vehicle 20 is designed to float at a level trim in the event of a breakthrough, so as to keep components that may be harmed by contact with ice away from the ice, and to prevent the ingress of water, such as via the engine intake or exhaust 30. The tracked amphibious vehicle 20 is generally configured in terms of the location of its internal machinery and other general components such that the center of gravity and center of buoyancy are generally aligned such that the tracked amphibious vehicle 20 floats at a level trim when in water. Further, ballasting may be adjusted to adapt for different vehicle uses and the weight of ancillary machinery and equipment, by moving, expelling and/or taking on fluids. For example, as indicated by the most closely spaced hatching in FIGS. 4 and 5 (FIG. 5 shows the tracked amphibious vehicle 20 after ice breakthrough, floating at a level trim.), with the embodiment shown in the drawings, the aft buoyancy tanks 36 and the aft chambers 72 may be filled with water to compensate for the weight of the snow-plow assembly 26. Further, other liquids contained within the hull 22, for example, drinking water, hydraulic fluid and fuel for the engine 30, could also be moved within the hull 22 to adjust the trim.

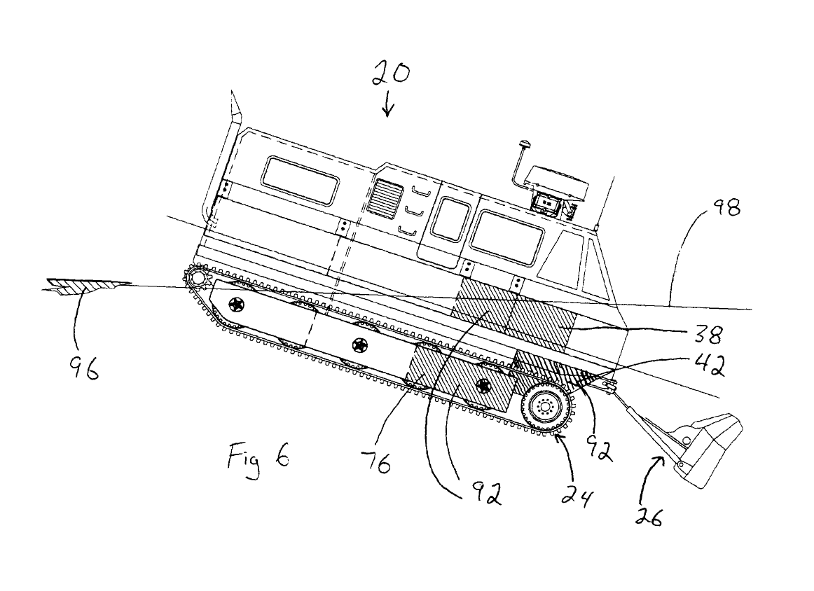

As shown in FIG. 6, responsive to the ice breakthrough: the water 92 that was in the aft buoyancy tanks 36 and aft chamber 72 has been removed, and the forward buoyancy tanks 38, forward chamber 76 and bow ballast tank 42 have been filled with water. In the result, in FIG. 6, the tracked amphibious vehicle 20 is floating at a full-bow-down trim position.

It has been found that tracked amphibious vehicles of the sort described herein are, when floating, able to obtain some motive force from fully submerged tracks. Why this is so is not clear, but it has been speculated that the bottom of each track may impart a greater propulsive force than the top of each track as a result of: the bottom of the track being slightly longer than the top of the track (as is the case in the present tracked amphibious vehicle 20 due to the location of the drive gear 62); and the top of the track being adjacent overhanging portions of the vehicle whereas the region adjacent the bottom of the track is clear of obstructions, such that when the track is moving, the water in the vicinity of the top of the track is subject to greater turbulence than the water in the vicinity of the bottom of the track. In any event, it is understood that when the tracked amphibious vehicle 20 is floating at a level trim it will be possible to manoeuver the tracked amphibious vehicle 20 using the tracks 60. Further, as a greater portion of the top of each track 60 than the bottom of each track 60 will be above the water surface 98 when the tracked amphibious vehicle 20 is floating in full-bow-down-trim such that the difference in the propulsive force provided by each of the top and bottom of each track 60 will be greater in full-bow-down-trim than when floating at a level trim, it is understood that the ability to manoeuver using the tracks 60 when floating in full-bow-down-trim will be greater than when floating at a level trim.

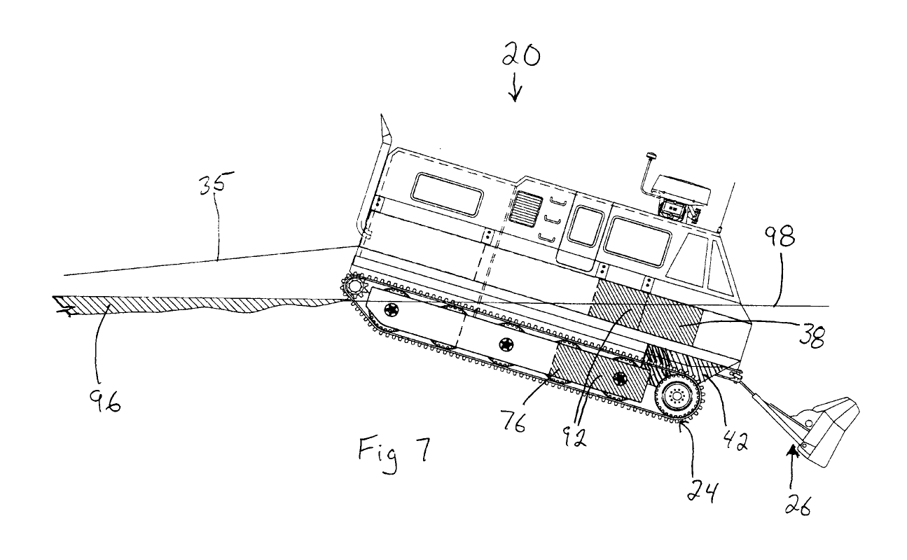

As shown in FIG. 7, once the tracks 60 have been used to bring the tracked amphibious vehicle 20 adjacent to the edge of the floating ice 96, it may be desirable to deploy the winch line 35, by securing the distal end of the winch line 35 to a following vehicle, a shoreline, or to the ice 96 via an ice anchor (not shown), so as to keep the tracks 60 in contact with the edge of the ice 96. An ice anchor is typically a threaded cylindrical device configured to be screwed into ice. Any suitable means for securing the distal end of winch line 35 may be used.

The winch 34 and winch line 35 are not intended to pull the tracked amphibious vehicle 20 out of the water and onto the ice 96, but rather are merely intended to assist the tracks 60 in gaining purchase on the ice 96 by: preventing the tracked amphibious vehicle 20 from bouncing away from the edge of the ice 96 as it might otherwise do as a result of the movement of the tracks 60 against the ice 96; and drawing the tracked amphibious vehicle 20 to the new edge of the ice 96 should the ice 96 break in the vicinity of the tracks 60.

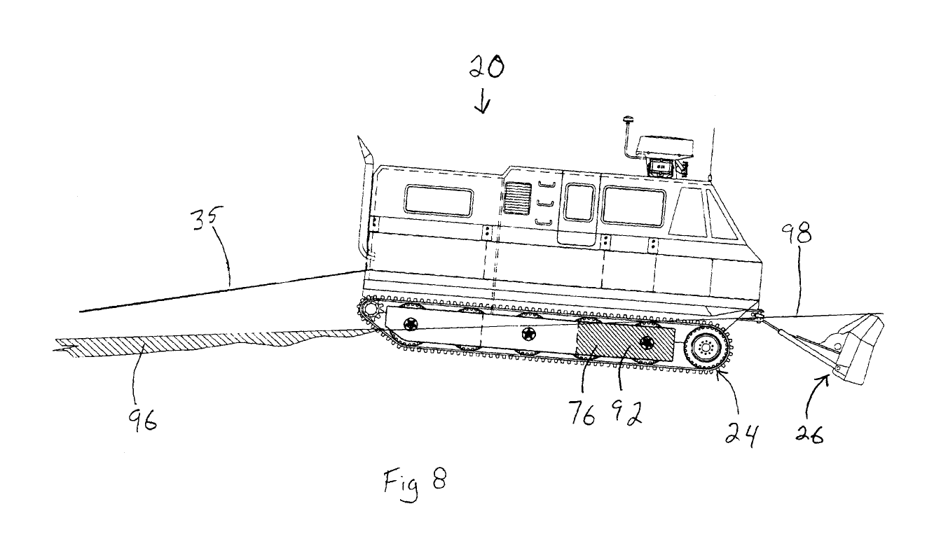

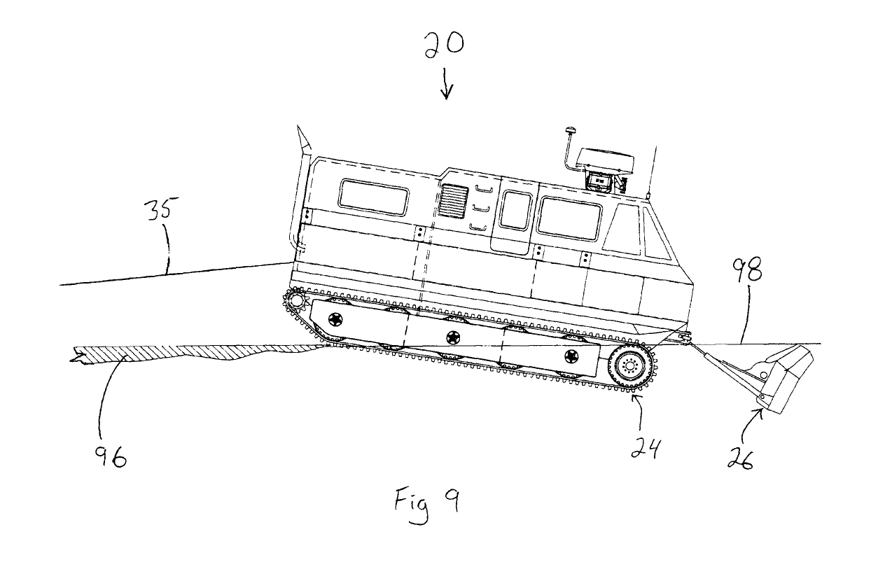

The full-bow-down-trim position raises the rear sections of the tracks 60, enabling them to usefully engage the edge of the ice 96. As shown in FIGS. 8 and 9, once the tracks 60 have sufficient purchase on the ice 96 to begin lifting the aft end of the tracked amphibious vehicle 20 out of the water 92, the water in the forward buoyancy tanks 38, bow ballast tank 42 and forward chamber 76 is expelled. This expulsion causes the forward end/bow of the tracked amphibious vehicle 20 to rise in the water 92, which change in the attitude of the tracked amphibious vehicle 20 both: applies greater weight to the rearward portion of the tracks 60 engaged with the ice 96 (thus enhancing the “grip” of the tracks 60 on the ice 96); and reduces the vertical component of the water-egress direction of travel of the tracked amphibious vehicle 20 (i.e., reduces the extent to which the tracked amphibious vehicle 20 has to climb, as opposed to merely travel essentially horizontally, to exit the water 92). Both of these facilitate the movement of the tracked amphibious vehicle 20 from the water 92 to the surface of the ice 96.

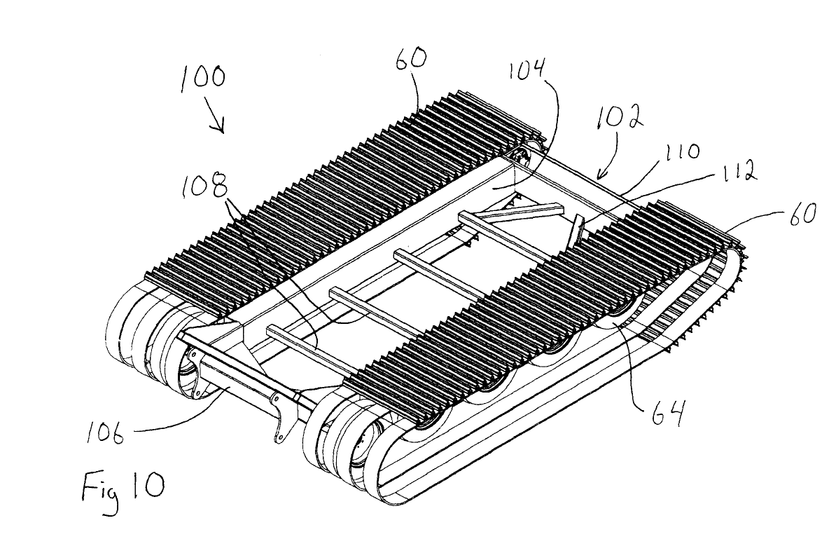

An alternative partial-integral-tank track assembly 100 is shown in FIG. 10. The partial-integral-floatation track assembly 100 has a side-and bow-floatation frame 102 having integral longitudinally extending floatation rails 104. The floatation rails 104 are held in a spaced-apart relationship by the bow floatation crossbeam 106, inner crossbeams 108, stern crossbeam 110 and braces 112. The floatation rails 104 and bow floatation crossbeam 106 are hollow and watertight, thus providing permanent floatation. Preferably, the inner crossbeams 108 and braces 112 are made from tubing (square tubing is indicated in FIG. 10) and are also configured to be watertight, thereby providing some additional floatation.

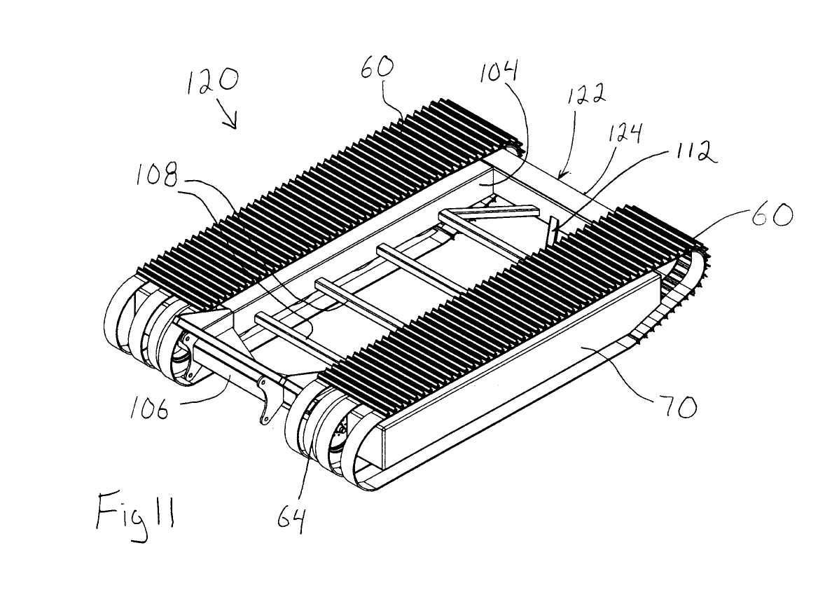

A further alternative, full-integral-tank track assembly 120 is shown in FIG. 11. The full-integral-tank track assembly 120 has a full-floatation frame 122 having integral longitudinally extending floatation rails 104 held in a spaced-apart relationship by the bow floatation crossbeam 106, inner crossbeams 108, stern floatation crossbeam 124 and braces 112. The floatation rails 104, bow floatation crossbeam 106 and stern floatation crossbeam 122 are hollow and watertight, thus providing permanent floatation. Preferably, the inner crossbeams 108 and braces 112 are made from tubing (square tubing is indicated in FIG. 11) and are also configured to be watertight, thereby providing some additional floatation.

As shown in FIG. 11, pontoons 70 (as described above), either segregated (e.g., aft chamber 72, middle chamber 74 and forward chamber 76; or more or fewer distinct chambers) or unsegregated (i.e. each pontoon 70 consisting of a single inner chamber) may be used with the full-integral-tank track assembly 120. Pontoons 70 may also be used with the partial-integral-floatation track assembly 100 (not shown).

Preferably, the tracked amphibious vehicle 20 of the present invention is configured such that filling and emptying a single tank or chamber is sufficient to provide the attitude adjustment for climbing onto floating ice from water as described above. Preferably, this single tank or chamber is located within the hull 22, as such a location simplifies: drawing water into and expelling water from the tank or chamber, and impeding ice formation within the tank or chamber.

What is claimed is:

1. A vehicle configured for use on floating ice, the vehicle comprising:
a) a track assembly, including a frame and two driveable tracks attached thereto, the tracks having an ice-engaging end;
b) a hull, mounted to and supported by the track assembly, wherein the track assembly and hull have positive buoyancy; and
c) an arrangement for adjusting the attitude of the vehicle between a neutral-trim position and an ice-engaging-end-up trim position when the vehicle is floating;
wherein, in use the vehicle may be moved from floating in water onto adjacent ice by, with the vehicle in the ice-engaging-end-up trim position, bringing the ice-engaging end of the tracks into engagement with the ice and driving the tracks so as to draw a portion of the tracks onto the ice and then adjusting to the neutral-trim position and continuing to drive the tracks.

2. The vehicle of claim 1, wherein the arrangement for adjusting the attitude of the vehicle comprises an adjustable ballasting arrangement comprising one or more tanks and water transfer assemblies whereby liquids may be selectively: drawn from and expelled to the surroundings, or shifted between tanks, or drawn from and expelled to the surroundings and shifted between tanks.

3. The vehicle of claim 2, wherein the tanks comprise two pontoons, one pontoon located within one of the tracks and the other pontoon located within the other of the tracks.

4. The vehicle of claim 3, wherein each pontoon is segregated into two or more chambers.

5. The vehicle of claim 1, wherein the arrangement for adjusting the attitude of the vehicle comprises an adjustable ballasting arrangement comprising a tank located in the hull and a water transfer assembly whereby water may be selectively drawn into the tank from the surroundings and expelled from the tank to the surroundings.

6. The vehicle of claim 1, wherein the neutral-trim position is a level-trim position.

7. The vehicle of claim 1, wherein the frame comprises watertight hollow structural components having integral floatation.

8. The vehicle of claim 7, wherein the watertight hollow structural components comprise two longitudinally extending beams and wherein each track is supported by an array of idler wheels and the idler wheels of one track are mounted to one of the beams and the idler wheels of the other track are mounted to the other of the beams.

9. The vehicle of claim 8, wherein the watertight hollow structural components further comprise one or more crossbeams interposed between the longitudinally extending beams.

10. The vehicle of claim 1, wherein each track is supported by an array of idler wheels and each track is driven by a drive gear located at the ice-engaging end.

11. The vehicle of claim 1, wherein the vehicle has a front and a back, and the ice-engaging end is at the back.

12. The vehicle of claim 1, further comprising a winch assembly located at the ice-engaging end for assisting in bringing the ice-engaging end into engagement with ice when the vehicle is floating in water.
